(19) United States
(12) Patent Application Publication
(10) Pub. No.: US 2004/0068045 A1
(43) Pub. Date: Apr. 8, 2004

(54) Use of latex for impregnating porous substrates

(76) Inventors: Isabelle Betremieux, Coye La Foret (FR); Christophe Verge, Coye La Foret (FR); Baudouin Duque, Bruxelles (BE)

Correspondence Address: WHYTE HIRSCHBOECK DUDEK S C, 555 EAST WELLS STREET, SUITE 1900, MILWAUKEE, WI, 53202, US

(21) Appl. No.: 10/466,200

(22) PCT Filed: Jan. 17, 2002
(86) PCT No.: PCT/FR02/00182

(30) Foreign Application Priority Data
Jan. 18, 2001 (FR) 01/00668

(51) Int. Cl. C08L 31/00

(52) U.S. Cl. 524/556

(57) ABSTRACT

The invention concerns the use in a treating composition for reinforcing porous substrates, of a latex based on polymer particles with diameter ranging between 50 and 200 nm having a proportion of solids ranging between 20 to 60 wt. % and containing acid functions.

The present invention relates to the area of surface processing, especially to processing that reinforces surfaces of porous substrates and more specifically, to processing that reinforces porous substrates using latex containing acid functions.

The painting of a new building or a building to be restored sometimes requires the use of a base coat or of a primer that makes the adhesion of the paint on the substrate possible, the needs being according to the different cases, since in the case of remodeling, the base is brittle and chalky, in contrast to a recent construction where the base materials are sound.

Buildings are also made up of base materials of many various types like cement, concrete, plaster or wood, and thus require base coats in aqueous phase or “universal and multibase” solvent.

The products used in this area mainly have a solvent base, as in the case of Impriderme, which involves a problem in terms of emission of volatile organic compounds and in terms of odor. Other products in aqueous phase having extremely small particle size are now proposed, but these products have the disadvantage that they are only slightly concentrate.

EP 0 644 205 A1 describes a method for obtaining latex with very fine particle size (less than 100 nm and preferably between 5 and 40 nm) having a rather low solids content, on the order of 25% and its use in various areas connected with coating (wood preservation, waterproofing, product for paper manufacturing, etc.).

This document is essentially based on the small size of the latex particles, the useful part essentially being exemplified in terms of penetration into the wood and of textile processing.

Rhodopas Ultrafine, like Ultrafine PR 3500, manufactured and marketed by Rhodia, has good characteristics in terms of the size of the particles, penetration and rheology. Because of this, they are used in the areas of solidifying chalky base materials, and of blocking salty penetrations.

The applicant has found that the problems caused in the past can be resolved with the use of a latex having a small particle size and containing acid functions.

The present invention concerns the use of latex synthesized in the presence of soluble alkali resins having acid groups, like styrene maleic anhydride copolymers or styrene (meth)acrylic acid, latex which thus presents elevated percentages of acid function, which is not the case of the latex traditionally used like REPOLEM 2423, of which the mass ratios of the acid monomer is less than 5%.

According to a second form, the invention concerns use of the latex synthesized in the presence of a macro or micromolecular surfactant, of which the dispersed polymer contains acid functions.

No matter what the form of the invention, the latex has average particle sizes around 100 nm, but can be obtained with elevated percentages of solids, greater than 25% and up to 50% which constitutes and undeniable advantage in use.

The advantage of the solution suggested by the present invention in comparison to the known solutions is that it makes it possible to use latex having dry extracts greater than 25%, and up to 50% and which, in spite of the size of the particle in some cases greater than 100 nm, leads to superior usage properties than those obtained with products in solvent phase and equivalent to those of known products with small particle size that have, in contrast, lower percentages of solids.

Thus the first object of the invention is the use, for reinforcing treatment of porous substrates, of a latex made up of at least one polymer dispersed in the from of particle with diameter between 50 and 200 nm and stabilized using at least one surfactant having a rate of solids between 20 and 60% by weight and preferably between 30 and 50%.

The Tg planned is between −10 and 60° C., preferably between 0 and 30° C.

The dry extract obtained is between 20 and 60%, preferably between 35 and 50%.

The size of the particles is between 50 and 200 nm, preferably between 80 and 120 nm, the Brookfield viscosity of the latex at 23° C. is between 50 and 5000 mPa.s, preferably between 100 and 2000 mPa.s.

The latex comprises 10 to 50% by weight of alkali-soluble copolymer based on styrene maleic anhydride (SMA) or styrene acrylic acid (SAA) and preferably 20 to 40% having an acid index from 100 to 500 mg KOH/g (global rate of acid monomer in the latex: 5 to 20%, even 30%), the rest of the solid fraction being made up of copolymer resulting from the polymerization.

The acid functions can also be carried by the dispersed polymer and/or by the surfactant.

According to the invention, the latex can be obtained by copolymerization in emulsion of the monomers in the presence, as an emulsifier, of at least one styrene maleic anhydride copolymer (SMA) or styrene acrylic acid (SAA) in aqueous solution and in partially or totally neutralized for or in partially or totally esterified form.

According to the invention, the latex can be obtained by copolymerization in emulsion of monomers, also in the presence of anionic or non-ionic emulsifying agents, traditionally used in emulsion polymerization.

The copolymer SMA or SAA (alkali-soluble copolymer) used in especially a copolymer having an average molecular mass by weight between 5000 and 15,000, a styrene maleic anhydride or styrene (meth)acrylic acid molar ratio between 1:1 and 6:1 and an acid index between 100 and 500 mg KOH/g. It is notable used in neutralized form in aqueous solution, the neutralizing agent may be an organic base such as an amine or ammonia or a mineral base such as soda, potash, etc.

By way of example of aqueous solutions of SMA copolymers that can be used in the present invention, it is possible to mention the aqueous solutions of styrene maleic anhydride copolymers in hydrolyzed form, neutralized with a sodium salt or with an ammonium salt, marketed by the “ATOFINA” company for the first, under the names:

SMA® 1000 HNa, SMA® 2000 HNa, SMA® 3000 HNa, and SMA® 4000 HNa, and for the second, under the names:

SMA® 1000H, SMA® 2000H, SMA® 3000H, and SMA® 4000H, It is also possible to mention, as base copolymers before being subjected to hydrolysis, the styrene maleic anhydride copolymers marketed by the “ATOFINA” company under the names:

SMA® 1000, SMA® 1000 G, SMA® 2000, SMA® 2000 G, SMA® 3000, SMA® 3000 G, SMA® 4000 and SMA® 3840.

By way of example of SAA copolymers, it is possible to mention the copolymers marketed by Johnson-Polymer such as Joncryl 678 or by Morton as Morez 101.

Styrene maleic anhydride copolymers can also be mentioned that are partially esterified using e.g. isopropanol or butanol, and particular those marketed by the “ATOFINA” company under the names:

SMA® 1440, SMA® 17352 and SMA® 2625.

An aqueous solution of SMA or SAA copolymer is advantageously used with a concentration from 10 to 40% by weight, preferably from 15 to 30% by weight.

The SMA copolymer is introduced in an amount of 10 to 50%, preferably from 20 to 30% by weight in comparison to the solid portion of the latex, the rest of the solid portion being made up of the styrene acrylic type copolymer resulting from the copolymerization.

The use of (meth)acrylic acid in small proportion in the styrene acrylic copolymer makes it possible to improve the stabilizing of the latex, to reduce the amount of coagulum formed, while reducing the rate of styrene maleic anhydride copolymer, which still more increases the amount of dry extract.

The polymerization is generally carried out in the presence of at least one radical polymerization primer chosen from among the hydrosoluble primers combined with a reducing agent and lipophilic primers. By way of example of hydrosoluble primers, ammonium, potassium or sodium persulfate, hydrogen peroxide or the hydroperoxides, such as tert.-butylhydroperoxide can be mentioned. By way of examples of lipophilic primers, the azo derivatives and the organic peroxides can be mentioned.

The polymerization is generally carried out at a temperature of 40 to 95° C., preferably from 65 to 85° C.

The polymerization can be carried out using a closed reactor process or a semi-continuous process, with the addition of the monomers generally being carried out over a period of time from 1 to 6 hours, the styrene maleic anhydride generally being introduced into the reactor at the start of polymerization.

The following examples illustrate the present invention without in any way limiting its scope. In these examples, the percentages are given by weight unless otherwise indicated.

In view of obtaining the desired Tg, the monomers are chosen, in a non-limiting manner, from among styrene, acrylic and methacrylic esters, etc.

The Tg planned is between −10 and 60° C., preferably between 0 and 30° C.

The dry extract obtained is between 20 and 60% and preferably between 35 and 50%. The size of the particles is between 50 and 200 nm, preferably between 80 and 120 nm, the Brookfield viscosity of the latex at 23° C. is between 50 and 5000 mPa.s, preferably between 100 and 2000 mPa.s.

The latex is evaluate din different dilutions on chalky base material made up of a mixture of cellulose thickener and of CaCO₃ filler, on plaster and gypsum plaster board comparatively with a primer in solvent phase (acrylic resin with 10% solids portion) marketed by the La Seigneurie Company under the name Impriderme P, the objective being to determine the reinforcing power.

### EXAMPLES

Examples will be used to illustrate the invention without limiting its scope.

### Example 1

In a glass reactor with a capacity of 3 liters, equipped with mechanical agitation, 1025.91 g of ammonia solution of SMA 2000H at 19.3% is introduced, to which is added 138.09 g demineralized water and the mixture is brought to 85° C. while being agitated.

In addition, an aqueous solution of ammonium persulfate is prepared by dissolving 10.8 g of ammonium persulfate in 120 g demineralized water.

A mixture of monomers is also prepared that is made up of 600 g monomers, distributed in the following way:

| Tests | 1.1 | 1.2 | 1.3 | 1.4 |
|---|---|---|---|---|
| Styrene (g) | 210 | 270 | 300 | 290 |
| ABU (g) | 290 | 330 | — | — |
| AE₂H (g) | — | — | 300 | 210 |

When the reaction mixture reaches 85° C., the feed of the primer solution and of the monomer mixture are started up simultaneously, they are introduced over 2 hours.

After the flows have ended, the reaction mixture is held at 85° C. for 2 more hours.

Then the mixture is cooled to ambient temperature, the reactor is drained and the mixture is filtered on a 100 micrometer cloth.

The latex obtained has the following characteristics:

| Tests | 1.1 | 1.2 | 1.3 | 1.4 |
|---|---|---|---|---|
| Coagulum (g) | 25 | 140 | 220 | 340 |
| Dry extract (%) | 38.9 | 39.3 | 40.1 | 41.7 |
| Viscosity (mPa · s) | 22000 | 26000 | 280 | 340 |
| Diameter (nm) | 116 | 124 | 110 | 112 |
| pH | 8.6 | 8.6 | 8.8 | 8.9 |
| Tg approximate (° C.) | 30 | 0 | 30 | 0 |

### Example 2

In a glass reactor with a capacity of 3 liters, equipped with mechanical agitation, ×g of ammonia solution of SMA 3000H at 14.9% is introduced, to which is added “y” g demineralized water and the mixture is brought to 85° C. while being agitated.

| Tests | 2.1 | 2.3 |
|---|---|---|
| x (g) | 1028.9 | 587.25 |
| y (g) | 490.1 | 694.42 |
| Total amount of SMA (%) | 30 | 20 |

In addition, an aqueous solution of ammonium persulfate is prepared by dissolving 6.25 g of ammonium persulfate in 125 g demineralized water.

A mixture of monomers is also prepared that is made up of 162.5 g styrene and 187.5 g butyl acrylate.

In the case of test 2.3, 3.5 g of methacrylic acid neutralized with 3.5 g of a 20% ammonia solution is introduced into the reactor before the flows start.

When the reaction mixture reaches 85° C., the feed of the primer solution and the solution primer and of the monomer mixture are started up simultaneously, they are introduced over 2 hours.

After the flows have ended, the reaction mixture is held at 85° C. for 2 more hours.

Then the mixture is cooled to ambient temperature, the reactor is drained and the mixture is filtered on a 100 micrometer cloth.

The latex obtained has the following characteristics:

| Tests | 2.1 | 2.3 |
|---|---|---|
| Coagulum (ppm) | 300 | 500 |
| Dry extract (%) | 25.5 | 25.9 |
| Viscosity (mPa · s) | <100 | <100 |
| Diameter (nm) | 66 | 64 |
| pH | 9.0 | 8.8 |
| Tg approximate (° C.) | 30 | 30 |

### Example 3

In a glass reactor with a capacity of 3 liters, equipped with mechanical agitation, 876 g of ammonia solution of SMA 1000H at 37% is introduced, to which is added 484.5 g demineralized water and the mixture is brought to 85° C. while being agitated.

In addition, an aqueous solution of ammonium persulfate is prepared by dissolving 13.5 g of ammonium persulfate in 270 g demineralized water.

A mixture of monomers is prepared that is made up of 279.72 g styrene, 461.16 g butyl acrylate, 7.56 g acrylic acid and 7.56 g acrylamide.

When the reaction mixture reaches 85° C., the feed of the primer solution and the solution primer and of the monomer mixture are started up simultaneously, they are introduced over 2 hours.

After the flows have ended, the reaction mixture is held at 85° C. for 2 more hours.

Then the mixture is cooled to ambient temperature, the reactor is drained and the mixture is filtered on a 100 micrometer cloth.

The latex obtained has the following characteristics:

| Tests | 3.1 |
|---|---|
| Coagulum (ppm) | 8 |
| Dry extract (%) | 45.9 |
| Viscosity (mPa · s) | 2600 |
| Diameter (nm) | 108 |
| pH | 8.6 |
| Tg approximate (° C.) | 0 |

### Example 4

In a glass reactor with a capacity of 3 liters, equipped with mechanical agitation, 761.54 g of ammonia solution of Joncryl 678 at 26% is introduced, to which is added 60.40 g distilled water and the mixture is brought to 85° C. while being agitated.

In addition, an aqueous solution of ammonium persulfate is prepared by dissolving 10.8 g of ammonium persulfate in 216 g demineralized water.

A mixture of monomers is prepared that is made up of 390 g styrene and 210 g butyl acrylate.

When the reaction mixture reaches 85° C., the feed of the primer solution and the solution primer and of the monomer mixture are started up simultaneously, they are introduced over 2 hours.

After the flows have ended, the reaction mixture is held at 85° C. for 2 more hours. while it is diluted by the addition of distilled water to bring the dry extract to around 30%.

Then the mixture is cooled to ambient temperature, the reactor is drained and the mixture is filtered on a 100 micrometer cloth.

The latex obtained has the following characteristics:

| Tests | 4.1 |
|---|---|
| Coagulum (ppm) | 200 |
| Dry extract (%) | 48.2 |
| Viscosity (mPa · s) | 100 |
| Diameter (nm) | 126 |
| pH | 7.6 |
| Tg approximate (° C.) | 50 |

### Example 5

In a glass reactor with a capacity of 3 liters, equipped with mechanical agitation, 434.21 g of ammonia solution of Morez 101 at 34.2% is introduced, to which is added 183.29 g distilled water and the mixture is brought to 85° C. while being agitated.

In addition, an aqueous solution of ammonium persulfate is prepared by dissolving 8.1 g of ammonium persulfate in 162 g demineralized water.

A mixture of monomers is prepared that is made up of 292.5 g styrene and 157.5 g butyl acrylate.

When the reaction mixture reaches 85° C., the feed of the primer solution and the solution primer and of the monomer mixture are started up simultaneously, they are introduced over 2 hours.

After the flows have ended, the reaction mixture is held at 85° C. for 2 more hours. while it is diluted by the addition of distilled water to bring the dry extract to around 30%.

Then the mixture is cooled to ambient temperature, the reactor is drained and the mixture is filtered on a 100 micrometer cloth.

The latex obtained has the following characteristics:

| Tests | 5.1 |
|---|---|
| Coagulum (ppm) | 20 |
| Dry extract (%) | 46.9 |
| Viscosity (mPa · s) | 540 |
| Diameter (nm) | 117 |
| pH | 8 |
| Tg approximate (° C.) | 50 |

### Example 6

### Application Evaluation on Chalky Base Material

Preparation of the chalky base material The chalky base material is made up of a mixture of calcium carbonates and titanium oxide (Durcal 10 and TiO₂ RL 68) dispersed in a cellulose thickening solution based on Natrosol 250 HR at 2%, which is applied by spraying of a sheet of agglopan (fiber-reinforced cement) with increasing thickness.

Application of Primers

The primer made up of non-formulated latex is applied with a brush to the chalky base prepared above and in excess, which is applied in different dilutions.

On the same sheet, the reference primer in solvent phase is also applied, which is marketed by the La Seigneurie Company under the name Impriderme P, a section of non-chalky base material without primary also being maintained as a reference.

| | | | | | | |
|---|---|---|---|---|---|---|
| | | | | | | Without |
| Dry | 12% | 6% | 3% | 1.5% | | primer |
| extract | ↓ | ↓ | ↓ | ↓ | Impriderme | ↓ |

| | |
|---|---|
| Thickness | 20 μm→ |
| of chalky | 50 μm→ |
| base | 100 μm→ |
| material | 1500 μm→ |

Diagram of Application on the Sheet

Application of the Finish

After drying 24 h at 23° C., 50% relative humidity, a finish based on gloss paint having a pigment volume concentration (CPV) of 17% or a matte paint with a CPV of 81% and this is allowed to dry for 8 hours at ambient temperature.

Adhesion Measurements

The adhesion of each finish on the base material impregnated with primer is evaluated. In order to measure this adhesion, a cross is cut into the finish by cutting down to the base, a piece of adhesive tape is applied to the notched zone, then it is pulled off abruptly.

The deterioration of the film is evaluated with a grade of 0 (poor) to 10 (excellent) as a function of the amount of residual adherence of the paint film and of its degree of deterioration:

[Please See Original for Illustration.]

| Dilution/ | | | | | | Without | Ultrafine |
|---|---|---|---|---|---|---|---|
| product | 1.3 | 2.1 | 3.1 | 4.1 | Impriderme | primer | PR 3500 |
| 12% | 9.2 | 8.3 | 9.2 | 9.4 | 9 | 1 | 5.7 |
| 6% | 8.3 | 9.1 | 8.3 | 7.6 | | | 8.9 |
| 3% | 7.4 | 8.8 | 6.8 | 9.0 | | | 6.4 |

Rating * Obtained for the Types of Latex Examined *The rating is the average value of all of the measurements carried out at one dilution, considering that 3 measurements were carried out for each thickness (each case).

### Example 7

### Evaluation of Application on Plaster

The substrate is a square of prefabricated plaster with a smooth surface (slightly glossy) and cohesive (no chalkiness). The primer is applied with a brush and in excess in 1 stroke, at different dilutions (dry extract of 12% to 1.5%).

After 24 h drying, the system is completed with the application of a layer of matte or flossy paint, identical to the paints mentioned above and the adhesion is tested in the same way as for the chalky base material.

| Dilution/ | | | | | Impri- | Without | Ultrafine | Repolem |
|---|---|---|---|---|---|---|---|---|
| product | 1.3 | 2.1 | 3.1 | 4.1 | derme | primer | PR 3500 | 2423 |
| 12% | 9 | 9.0 | 9 | 8.0 | 7.3 | 2 | 7.1 | 4.1 |
| 6% | 9 | 9.0 | 9 | 7.1 | | | 8.0 | 5.0 |
| 3% | 9 | 9.0 | 9 | 7.8 | | | 6.2 | 5.0 |
| 1.5% | 8.5 | 8.0 | 8.3 | 8.0 | | | 6.8 | |

Rating * Obtained for the Types of Latex Examined *The rating is the average value of the 3 measurements carried out at each dilution.

### Example 8

### Evaluation of Application on Gypsum Plaster Board

The substrate is a panel of gypsum plaster board, 13 mm thick. The tests were carried out on the back of the sheet, the application and the tests being carried out using the same method as for plaster and on chalky base material.

| Dilution/ | | | | | Without |
|---|---|---|---|---|---|
| product | 1.3 | 2.1 | 3.1 | Impriderme | primer |
| 12% | 0.3 | 0.3 | 0.3 | 3.3 | 1 |
| 6% | 2.3 | 0.3 | 2 | | |
| 3% | 3.7 | 2.3 | 3.7 | | |
| 1.5% | 4.3 | 1 | 4.3 | | |

Rating * obtained for the types of latex examined *The rating is the average value of 3 measurements carried out at one dilution.

1. A method for reinforcing porous substrates, the method comprising the step of applying a latex to a porous substrate wherein the latex comprises at least one polymer dispersed in the form of particles with diameter between 50 and 200 nm, is stabilized with at least one surfactant, and has a solids content between 20 and 60%, characterized in that the latex further comprises between 10 and 50% by weight in relationship to the dispersed polymer of alkali-soluble polymer.

2. The method of claim 1, characterized in that the latex has a solids content greater than 25%.

3. The method of claim 2, characterized in that the latex has a solids content between 35 and 50%.

4. The method of claim 1, characterized in that the average diameter of the dispersed particles is between 80 and 120 nm.

5. The method of claim 1, characterized in that the alkali-soluble polymer is chosen from the group consisting of styrene maleic anhydride, styrene acrylic, and methacrylic acid or combinations thereof.

6. The method or combinations thereof of claim 1, characterized in that the akali-soluble polymer has an acid index between 100 and 500 g of KOH/g.

7. The method of claim 1, characterized in that the akali-soluble polymer has an average molecular mass by weight between 5000 and 15000.

8. The method of claim 1, characterized in that the akali-soluble polymer has a styrene to maleic anhydride ratio or styrene to (meth)acrylic acid ratio between 1 and 6.

9. A porous substrate treated with a reinforcing latex according to claim 1.
